(19) United States
(12) Patent Application Publication
(10) Pub. No.: US 2013/0318007 A1
(43) Pub. Date: Nov. 28, 2013

(54) LIFETIME INCOME ANALYSIS TOOL

(71) Applicant: Putnam Investments, Boston, MA (US)

(72) Inventors: William Van Harlow, Concord, MA (US); Paul P. O'Connell, Wilmington, MA (US); David R. Nguyen, Newton, MA (US); Staci Dubovik, Framingham, MA (US); Eric H. Sagalyn, Carlisle, MA (US)

(21) Appl. No.: 13/900,978

(22) Filed: May 23, 2013

Related U.S. Application Data
(60) Provisional application No. 61/650,782, filed on May 23, 2012.

(51) Int. Cl. G06Q 40/06

(52) U.S. Cl. CPC G06Q 40/06
USPC 705/36 R

(57) ABSTRACT

A lifetime income analysis tool (LIAT) that includes a client-based application that provides selective information relating to an individual's retirement. The client-based application processes the selective information to be sent as a request. A server-based application receives the request and processes the request to evaluate the feasibility of an individual's retirement income goal. The server-based application also provides a customized estimate of expected future monthly income needed to cover a broad range of health-care costs in retirement utilizing a plurality of LIAT factors. The server-based application sends its findings as a response to the client-based application for viewing by a user.

### PRIORITY INFORMATION

This application claims priority from provisional application Ser. No. 61/650,782 filed May 23, 2012, which is incorporated herein by reference in its entirety.

### BACKGROUND OF THE INVENTION

The invention is related to the field of retirement calculation tools, and in particular to allowing users to incorporate retirement income and healthcare costs in evaluating their retirement options.

Traditional investor software provides asset allocation guidance and/or advice based on risk-reward trade-offs and investor risk preferences or goals. Some of these software packages provide asset class level guidance and/or advice, but leave the investor unsure of how to allocate to actual investable financial products.

More recently, a plethora of “retirement calculators” have become available to provide income forecasts at retirement based on static growth rates. More sophisticated versions allow Monte-Carlo simulations based on static investment strategies. These include “buy and hold” assumptions about the asset classes or periodically rebalanced to the original composition. Some of these calculators require the investor to input capital market assumptions such as future inflation and expected returns until investment horizons.

These tools allow the investor to unrealistically manipulate economic variables to attain wishful retirement goals, and thus the resulting guidance and/or advice is misleading and dangerous. Careful calibration of the capital market assumptions by experts in the field is critical to providing an accurate long-term forecast for the investor. What is needed is a system that can either generate the capital market assumptions based on an accepted methodology and/or provide the capability for a registered investment advisor (RIA) or other asset manager to upload their existing capital market assumptions used across their business.

The prior art includes a retirement calculator that provides automated managed accounts solutions. This system maps the available set of recommendable investments to the investor into an asset classes. It then performs a portfolio optimization to create an efficient risk/reward frontier for the investment horizon, and from this frontier picks the ideal asset class portfolio that maximizes the investor's utility function. The system then implements the investable portfolio that corresponds to this ideal asset class portfolio from the list of invertible securities available to the investor.

### SUMMARY OF THE INVENTION

According to one aspect of the invention, there is provided a lifetime income analysis tool (LIAT). The LIAT includes a client-based application that provides selective information relating to an individual's retirement, and allowing users to customize and visualize their retirement plan to determine viability and estimate expected future monthly income needed to cover a broad range of health care costs in retirement utilizing a plurality of LIAT factors. A server-based application receives the request and processes the request to evaluate the feasibility of an individual's retirement income goal. The server-based application also provides a customized estimate of expected future monthly income needed to cover a broad range of health-care costs in retirement utilizing a plurality of LIAT factors. The server-based application sends its findings as a response to the client-based application for viewing by a user.

According to another aspect of the invention, there is provided a method of performing retirement planning analysis. The method includes providing selective information relating to an individual's retirement using a client-based application, and allowing users to customize and visualize their retirement plan to determine viability and estimate expected future monthly income needed to cover a broad range of health care costs in retirement utilizing a plurality of LIAT factors. Also, the method includes receiving and processing requests from the client-based application using a server-based application to retrieve and store retirement plan information.

### BRIEF DESCRIPTION OF THE DRAWINGS

FIG. 1 is a graph illustrating cash flows over the timeline of an exemplary life;

FIG. 2 is a schematic diagram illustrating the service communication used in accordance with the invention;

FIG. 3 is a schematic diagram illustrating a detail overview of the server used by the invention; and

FIG. 4 is a schematic diagram illustrating a client-based user interface of the LIAT as viewed by a user;

FIG. 5 is a schematic diagram illustrating the use of spark lines to define healthcare expense;

FIG. 6 is a schematic diagram illustrating a detailed report on total estimated healthcare costs; and

FIG. 7 is a schematic diagram illustrating the use of personalized healthcare costs.

### DETAILED DESCRIPTION OF THE INVENTION

The invention employs a straightforward and robust approach to evaluating the viability of an individual's retirement plan. The invention can aid employees model how much monthly income their savings might generate in retirement and determine whether they are on track to maintain their current lifestyle once they stop working. Moreover, the invention is able to provide their participants with a customized estimate of how large a slice of their expected future monthly income will be needed to cover their broad range of health-care costs in retirement, including itemized insight on medical, dental and pharmaceutical expenses, at different age points. The projections can be generated from individual participant data and cost models using proprietary actuarial-based guidelines and expressed as monthly costs.

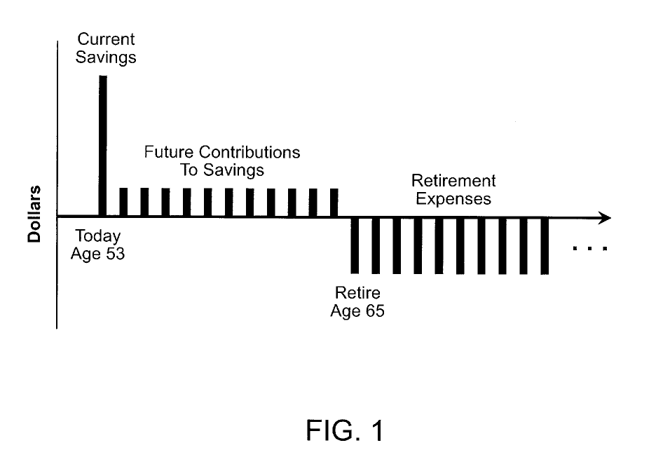

The invention utilizes a Lifetime Income Analysis Tool (LIAT) to employ a straightforward and robust approach to determining the viability of an individual's retirement plan. It is helpful to think of a retirement plan as nothing more than a series of projected cash inflows and outflows. Inflows reflect the amount of current savings and any additional savings made prior to retirement. Outflows are the funds consumed as expenses in retirement. Conceptually, a retirement plan looks like the following graph of cash flows over the timeline of one's life, as shown in FIG. 1.

Like any series of cash flows associated with a financial investment, these flows can be evaluated to see if they make sense and balance out when the time value of money is considered. In other words, will the assets fund the future liabilities. The standard approach for such an evaluation is to compute the net present value of the cash flows, i.e., discount all of the flows. Since we are dealing with retirement, we will call this summary number the Retirement Present Value (RPV).

As an illustration of the RPV calculation, consider an extremely simple example in which a woman has $100 in savings. She will work for one more year and contribute an additional $10 to savings. Then she will retire for one year and one year only and spend $125 in that year. Also, assume the interest rate on savings is 10% and is known with certainty. The RPV for this oversimplified retirement case is:

RPV=$100+$10/(1+0.10)−$125/(1+0.10)²=$5.79

The positive RPV of $5.79 implies that this is a viable and sustainable retirement plan. In fact, it is over funded by $5.79 in today's dollars. Even though our retiree contributed $110 in total to their retirement savings, the fact that it was earning 10% interest provided enough additional savings growth to fund $125 in retirement. However, if the interest rate on savings was only 6%, the RPV would become a negative $1.82. Hence, this retirement plan would fail to fund the desired $125 in retirement. An adjustment would need to be made to the plan such as contributing more to savings or spending less in retirement.

Of course, in this simple example one can assume that future interest rates were known with certainty. In practice, Monte Carlo simulation can be used to define an entire range of possible returns. In doing so, there is no single RPV value but an entire distribution of values. The goal of LIAT calculations is to present retirement income numbers that reflect the fact that 90% of the RPVs were positive. In other words, the plan has a 90% probability of success.

The one factor that is not discussed, but that is incorporated in the RPV methodology of LIAT is that of mortality risk. Certainly, any retirement plan is subject to the reality that you might live beyond average life expectancy and have to fund many additional years of retirement expenses. Conversely, you might die relatively early leaving an estate to your heirs. To capture this risk, the potential cash flows are multiplied by the probability of surviving to that year. That is, if there is 95.2% probability of a 60 year old female surviving to age 65, then the cash flow at age 65 is reduced by the probability weighting (0.952 times cash flow). In the LIAT version with health care, this probability is dependent, not only on age and gender, but on the health status of the individual.

Mathematically, the RPV method is simply an expression of the financial value of a retirement plan in today's dollars. It captures both mortality risk and the uncertainty around investment returns by discounting the cash inflows and outflows of the retirement plan in the appropriate manner. The calculation of the RPV is straightforward and merely an adaptation of the familiar method of determining the discounted present value of a series of future cash flows. The equation for the probability-weighted discounted cash flows is:

$$RPV = {\sum }_{i = 0}^{∞} \frac{{p}_{t} {CF}_{t}}{{( 1 + {R}_{t} )}^{t}} \qquad ( 1 )$$

where t=years into the future, pₜ=probability of being alive at time t, CFₜ=cash flow at time t, and Rₜ=discount rate.

The cash flows of the retirement plan, CFₜ in equation (1), represent savings inflows into the portfolio prior to retirement age and the outflows from living expenses after retirement. CF₀ in the RPV analysis represents the individual's current savings at time t=0.

For purposes of determining the discount rate, Rₜ, the returns on the investment portfolio in each year are used. These returns, denoted rₜ, are obtained from historical time series or through Monte Carlo simulation. The discount rate is thus:

(1+Rₜ)^{t}=(1+r₁)(1+r₂)(1+r₃) . . . (1+rₜ) (2) and

rₜ=wₛrₛₜ+w_{B}r_{Bt} (3)

where wₛ and W_{B} are the portfolio weights in stocks and bonds, respectively; rₛₜ and r_{Bt} are the returns on stocks and bonds at time t, respectively.

The probability of being alive at time t, pₜ, can be obtained directly from actuarial tables or through standard mathematical models specified to approximate the actual probability values. For the analyses used in LIAT, we adopt the standard Gompertz-Makeham model of the conditional probability of survival, i.e.,

pᵣ=e^{└(e}^{^{(x-m)/b}}^{)(1-e}^{^{t/b}}^{)┘} (4)

where t=years into the future, x=current age of the individual, and m and b are parameters chosen to create the best fit of the actuarial values based on the health status of the individual.

In order to evaluate how much income an individual is able to generate in retirement, we need to know two pricing factors: (i) the amount of current savings required today to generate $1 per year of real income in retirement, and (ii) the amount of annual savings required today to generate $1 per year of real income in retirement. These two pricing factors can be determined by setting the CFₜ in retirement to $1. The pre-retirement cash flows, CF₀ (current savings) or CFₜ (future savings), can then be estimated by a numerical search algorithm than sets the 0^{th}-order lower-partial moment of the RPV distribution, i.e., the probability of ruin, to 10%. Specifically,

$${LPM}_{0} = {{\sum }_{{RPV}_{1} < τ}}^{τ} {( τ - {RPV}_{j } )}^{0} / ( n - 1 ) = 0.10$$

where RPVⱼ=j^{th} RPV outcome from the set of n observations [equations (1), (2), (3), and (4)] generated from return simulations and τ=target value of zero.

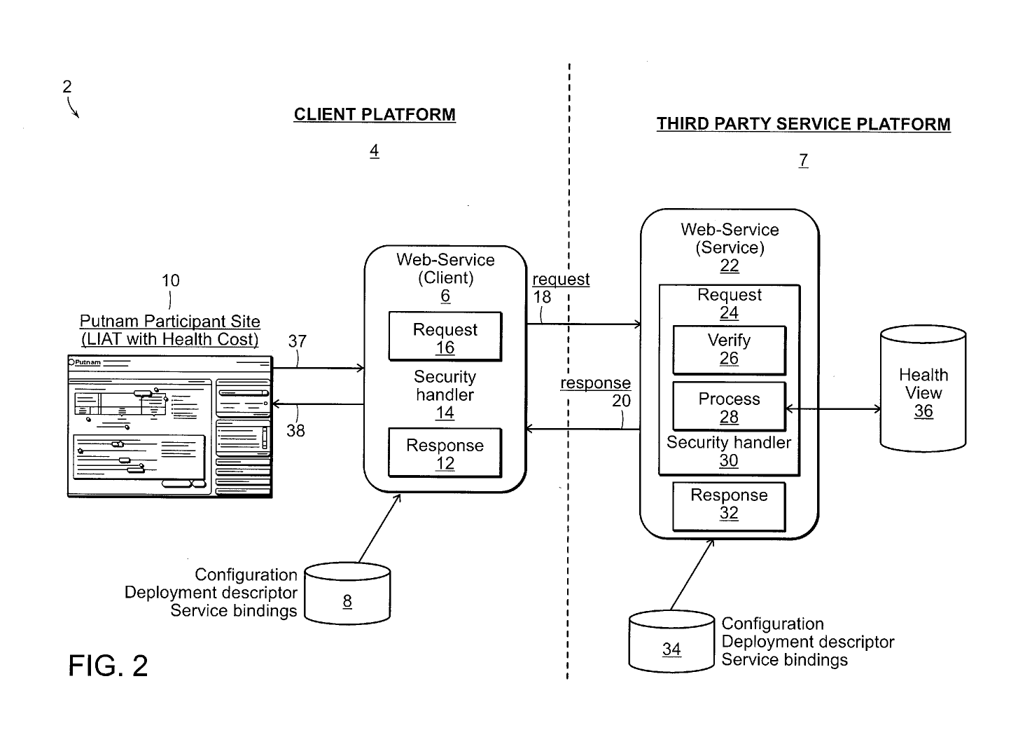

FIG. 2 shows a schematic diagram illustrating the service communication 2 used in accordance with the invention. The service communication 2 defines the service components used to create the platform for the inventive LIAT having a client platform 4, defined by a client 10 and a server 6, and third-party service platform 7. A user can interact with LIAT thru any web-based client application 10 that leverages HTML, CSS, and JavaScript, such as a web browser. The user inputs data 37 such as age, gender, health condition, current salary, and any relevant personal information for processing. This information is managed by a client-based server 6 that formats the information for transmission to the third-party service platform 7 as a request 18. In particular, the client-based web-service 6 uses the request handler 16 to generate a secure token using a public certificate for each request to the third-party service platform 7. The security handler 14 generates the required security headers used by the request handler. While the configuration deployment descriptor service bindings 8 specify the security requirements for the client-based server 6.

A request 18 is received by a third-party service platform 7 that executes the server-based web-service 22. The server-based web-service 22 includes a request handler 24 having routines to process the request 18 useable by the third-party service platform 7. The request handler 24 include a verify module 26 that makes sure the request 18 comes has the proper shared key or public certificate. A process module 28 uses data regarding health conditions and the state of retirement and returns monthly health care costs. The security handler 30 provides the required security headers used by the response handler 12. The configuration deployment descriptor service bindings 34 specify the security requirements for the server-based web-service 22. The response module 32 generates XML data once the server processes the request 18 to be sent back to the as a response 20 to the client-based web-service 6.

The client-based server 6 receives the response to processes the response to be in a format executable by the client 4. The client-based web-service 6 utilizes a response module 12 to develop and process the XML data in a format that is presentable by LIAT as output 38.

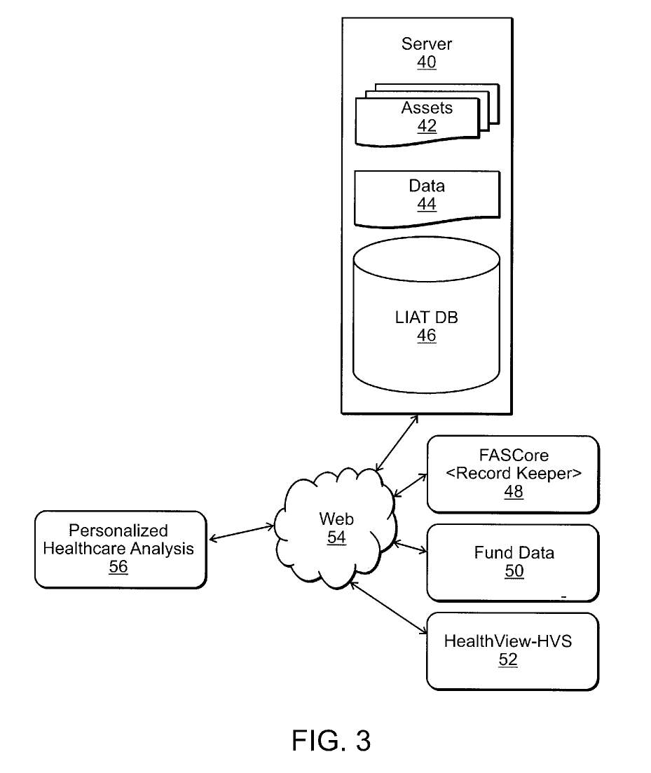

FIG. 3 is a schematic diagram illustrating a detail overview of the server 40 used by the invention. The server 40 is part of the implementation defining LIAT. The server 40 includes assets data 42 that is either stored in a database or secure memory in the server. Asset data includes information regarding definable assets that can be owned by users and their respective amounts. Moreover, the server 40 includes data 44 associated with a client social security or other identification information. LIAT DB 46 (database) is a database that stores LIAT factors that are later used to evaluate the viability of an individual's retirement plan. LIAT factors rely on actuarial data, such as mortality curves and health costs, to provide predetermine computed factors to be stored in the LIAT DB. In particular, the LIAT DB includes factors like health conditions, income level, company match rules, and Van Harlow factors.

The server 40 also utilizes third party providers 48, 50, 52 to facilitate access to record keeping data, healthview services information, and fund data. In particular, the third party service FASCore 48 provides record keeping information such as age, sex, balance, salary, information regarding deferral rates. The third party service provider Fund Data 50 serves information on fund specifics needs to compute a user's retirement information under LIAT. Moreover, the third party service provider HealthView services 52 provides information on actuarial data and other needed information to produce LIAT factors stored in the LIAT DB. Note the third party service providers communicate their results via the web 54 to the server 40. Furthermore, a personalize healthcare analysis service 56 is provided, which stores LIAT based information allowing users to have personalized detail analysis on their retirement goals based on their respective health conditions.

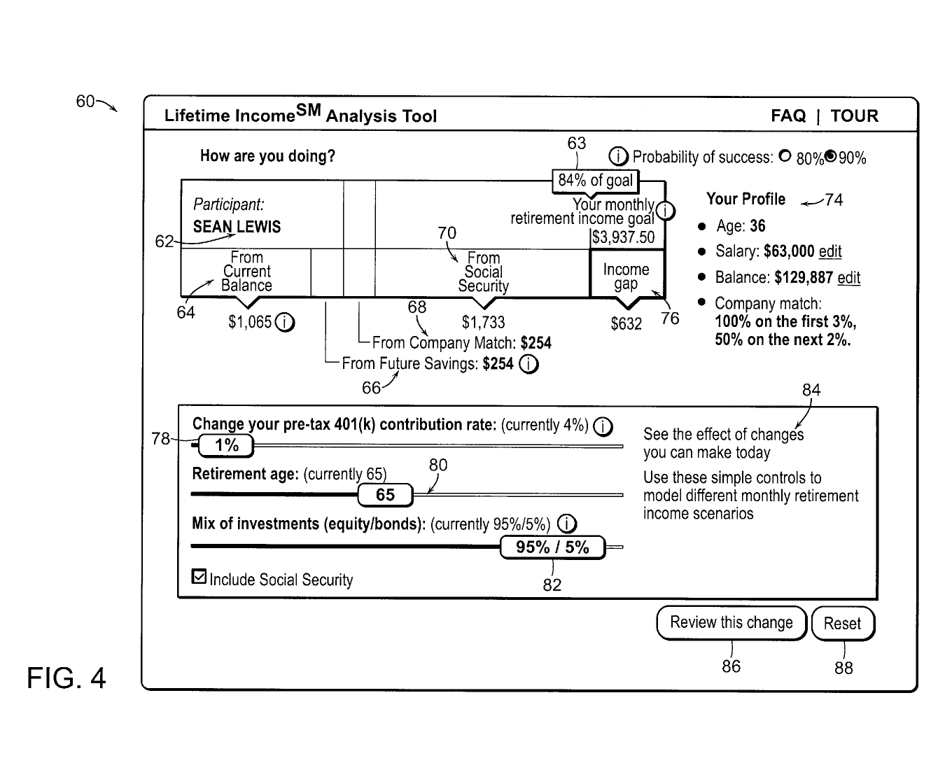

FIG. 4 is a schematic diagram illustrating a client-based user interface 60 of the LIAT analysis as viewed by a user. As indicated herein, any web-based client application that supports HTML, CSS, and JavaScript, such as a web browser, can be used to replicate the client-based user interface 60. As discussed above, the server provides the results of its LIAT analysis to the user via the user interface 60. The user interface 60 includes fields to indicate the participant 62, the participant profile 74, percentage of goal a user intends to have at retirement 63, futures savings 66, contributory matching 68, income gap 76, and current balance 64. Moreover, the user interface 60 includes adjustable sliders indicating changes in contribution rate 78, retirement age 80, and percentage of mix investments 82. A progress field 84 is provided by the user interface to indicate to the user what steps are needed to be within the expected retirement goal of a user. If the user changes the position of the adjustable sliders 78, 80 or 82, then the button 86 allows the user to review any changes before further calculations are performed on the new parameters submitted. The reset button 88 allows the user to reset the data provided. In addition to changing the sliders, the user can also change some of the aforementioned items, such as fields described herein. In other embodiments of the invention the user can adjust social security, probability of success, salary, outside balances, tooltips, and a health care cost graph.

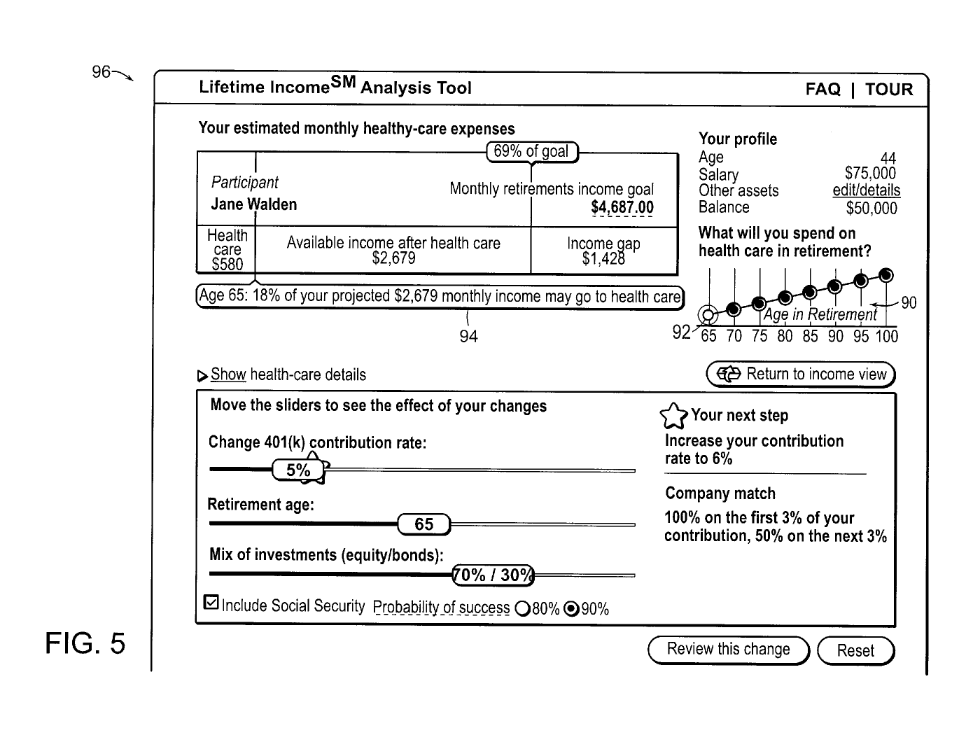

FIG. 5 is a schematic diagram illustrating the use of spark lines 90 to define healthcare expense. The user interface 96 is similar to the user interface 60 with the exception of the spark lines 90. The spark lines 90 include a number of dots 92 to define the age of user in retirement. When a user interacts with one of these dots 92 a dialog box 94 is introduced allowing users to see how much of their retirement income will be needed to set aside for healthcare expenses at that selected age.

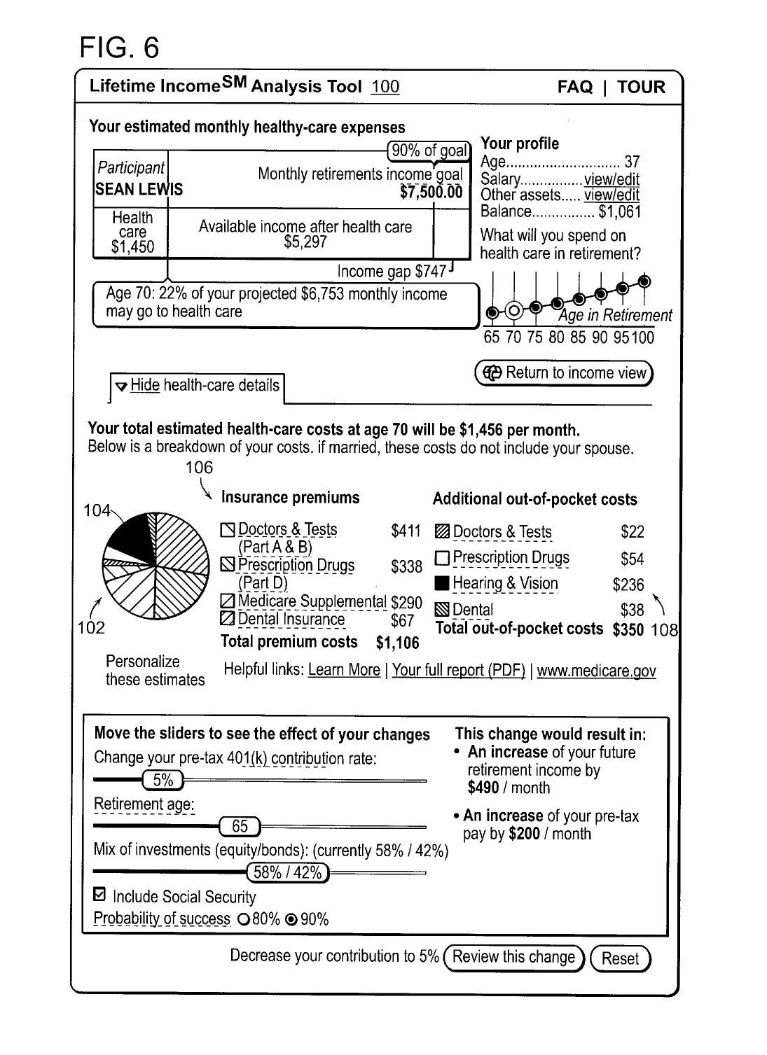

FIG. 6 is a schematic diagram illustrating a detailed report on total estimated healthcare costs. The user interface 100 is similar to the user interface 60 with the exception of the detailed report section 102. The detailed report section 102 includes a pie chart 104 divided into sectors demonstrating the numerical portion of each of the factors affecting the total estimated healthcare costs. Also, the detailed report section 102 includes an insurance premium section 106 showing selective insurance premium factors that affects the total estimated healthcare costs. Moreover, the detailed report section 102 includes an additional out-of-pocket cost section 108 illustrating those additional out-of-pocket factors affecting the total estimated healthcare costs. All of these factors are color coded and illustrated in the pie-chart 104.

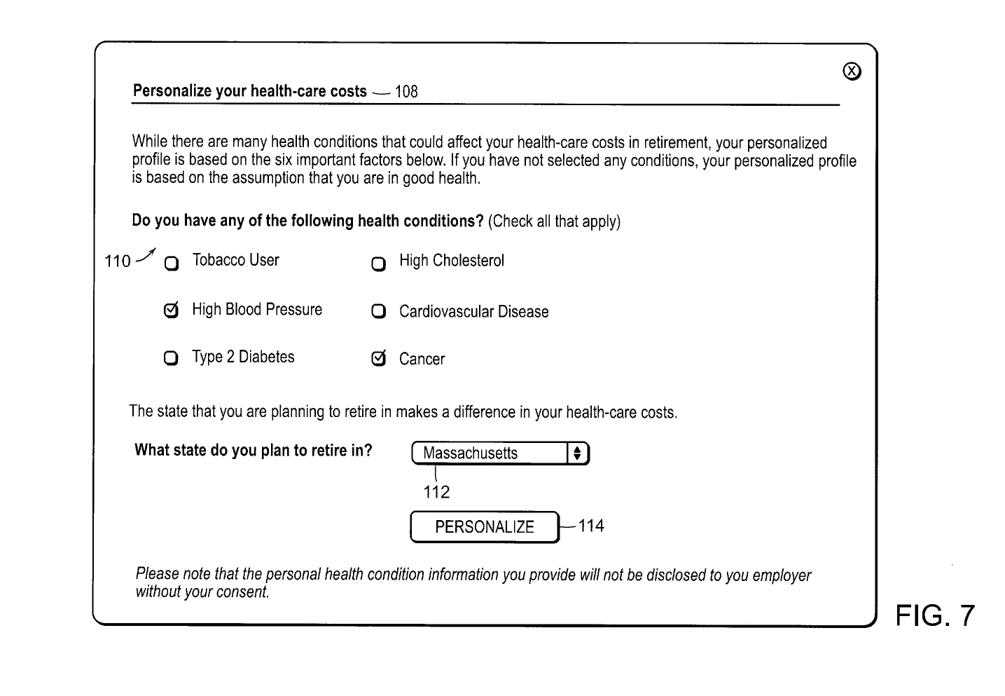

FIG. 7 is a schematic diagram illustrating the use of personalized healthcare costs. The invention also provides an option to users preferring a more detailed analysis based on their pre-existing health conditions and the feasibility of their retirement income goals. Using the personalized healthcare analysis service 56, a user interface 108 is provided where a user selects a one or more boxes 110 indicating their current health conditions. A check box 112 is provided where the user selects the state they live in, and when the user is done they can press the personalize button 114 to generate a detailed analysis of the feasibility of their retirement income goals in view of their present health condition.

The invention utilizes a novel approach in evaluating the feasibility of an individual's retirement plan. The invention is positioned in a network environment where users can access their calculated retirement information utilizing LIAT analysis to see how their retirement and healthcare costs are affected. Moreover, the invention permits participants to customize how much their expected future monthly income will be needed to cover their broad range of health-care costs in retirement, including itemized insight on medical, dental and pharmaceutical expenses, at different age points. The projections can be generated from individual participant data and cost models using proprietary actuarial-based guidelines and expressed as monthly costs.

Although the present invention has been shown and described with respect to several preferred embodiments thereof, various changes, omissions and additions to the form and detail thereof, may be made therein, without departing from the spirit and scope of the invention.

What is claimed is:

1. A lifetime income analysis tool (LIAT) comprising:
a client-based application that provides selective information relating to an individual's retirement, and allowing users to customize and visualize their retirement plan to determine viability and estimate expected future monthly income needed to cover a broad range of health care costs in retirement utilizing a plurality of LIAT factors; and
a server-based application that receives and processes requests from the client-based application to retrieve and store retirement plan information.

2. The LIAT of claim 1, wherein the client-based application leverages HTML, CSS, and JavaScript.

3. The LIAT of claim 2, wherein the client-based application runs in a web browser.

4. The LIAT of claim 1, wherein the server-based application utilizes third party providers to access information.

5. The LIAT of claim 1, wherein the server-based application comprises a database to store LIAT factors.

6. The LIAT of claim 5, wherein the server-based application stores actuarial data to compute the LIAT factors.

7. The LIAT of claim 1, wherein the server-based application comprises asset data that is stored in a database or secured memory.

8. The LIAT of claim 1, wherein the server-based application utilizes a third party service provider to maintain selective client's record keeping information.

9. The LIAT of claim 1, wherein the client-based application provides a user interface that allows a user to customize and visualize LIAT analysis data.

10. A method of performing retirement planning analysis comprising
providing selective information relating to an individual's retirement using a client-based application, and allowing users to customize and visualize their retirement plan to determine viability and estimate expected future monthly income needed to cover a broad range of health care costs in retirement utilizing a plurality of LIAT factors; and
receiving and processing requests from the client-based application using a server-based application to retrieve and store retirement plan information.

11. The method of claim 1, wherein the client-based application leverages HTML, CSS, and JavaScript.

12. The method of claim 2, wherein the client-based application runs in a web browser.

13. The method of claim 1, wherein the server-based application utilizes third party providers to access information.

14. The method of claim 1, wherein the server-based application comprises a database to store LIAT factors.

15. The method of claim 5, wherein the server-based application stores actuarial data to compute the LIAT factors.

16. The method of claim 1, wherein the server-based application comprises asset data that is stored in a database or secured memory.

17. The method of claim 1, wherein the server-based application utilizes a third party service provider to maintain selective client's record keeping information.

18. The method of claim 1, wherein the client-based application provides a user interface that allows a user to customize and visualize LIAT analysis data.
